(19) United States
(12) Patent Application Publication
(10) Pub. No.: US 2024/0047654 A1
(43) Pub. Date: Feb. 8, 2024

(54) LITHIUM-RICH, MANGANESE-RICH LAYERED ELECTROACTIVE MATERIALS AND METHODS OF FORMING THE SAME

(71) Applicant: GM GLOBAL TECHNOLOGY OPERATIONS LLC, Detroit, MI (US)

(72) Inventors: Gongshin QI, Troy, MI (US); Lei WANG, Rochester Hills, MI (US)

(73) Assignee: GM GLOBAL TECHNOLOGY OPERATIONS LLC, Detroit, MI (US)

(21) Appl. No.: 17/882,936

(22) Filed: Aug. 8, 2022

(51) Int. Cl. H01M 4/36; H01M 4/525; H01M 4/505; H01M 4/485

(52) U.S. Cl. CPC H01M 4/366; H01M 4/525; H01M 4/505; H01M 4/485; H01M 2004/028

(57) ABSTRACT

An electroactive material for an electrochemical cell is provided. The electroactive material includes a plurality of lithium-rich, manganese-rich layered electroactive material particles, where at least a portion of the lithium-rich, manganese-rich layered electroactive material particles defining the plurality has a coating that includes an oxygen storage material. The coating that includes the oxygen storage material has an average thickness greater than or equal to about 100 nanometers to less than or equal to about 2 micrometers, and the oxygen storage material is selected from the group consisting of: La₍₁₋ₓ₎SrxMnO₃ (where 0≤x≤0.3), La₍₁₋ₓ₎SrₓFeO₃ (where 0≤x≤0.3), La₍₁₋ₓ₎CaₓMnO₃ (where 0≤x≤0.3), La₍₁₋ₓ₎BaₓMnO₃ (where 0≤x≤0.3), LaMnO₃, LaFeO₃, LaMnO₃, LaFeO₃, CeO₂, CeO₂—MnOₓ (where 3≤x≤4), CeO₂—FeOₓ (where 2≤x≤3), CeO₂—WO₃, CeO₂—MoO₆, and combinations thereof.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. For example, in various aspects, positive electrodes may include lithium-rich, manganese-rich layered electroactive materials, for example as represented by xLi₂MnO₃·(1−x)LiMO₂ (where M is selected from the group consisting of: manganese (Mn), nickel (Ni), cobalt (Co), iron (Fe), and combinations thereof and 0.1≤x≤0.9), which are capable of providing improved capacity capabilities (e.g., greater than about 200 mAh/g) at high operating voltages (e.g., greater than about 4.4 V). Such materials, however, are often susceptible to high irreversible capacity loss during formation cycles and, as a result, poor cycling stability. Accordingly, it would be desirable to develop battery materials that can help to address these challenges.

### SUMMARY

This section provides a general summary of the disclosure, and is not a comprehensive disclosure of its full scope or all of its features.

The present disclosure relates to particle coatings for lithium-rich, manganese-rich layered electroactive materials, to electrodes and electrochemical cells including coated lithium-rich, manganese-rich layered electroactive material particles, and to methods of making and using the same.

In various aspects, the present disclosure provides an electroactive material for an electrochemical cell that cycles lithium ions. The electroactive material may include a plurality of lithium-rich, manganese-rich layered electroactive material particles, where at least a portion of the lithium-rich, manganese-rich layered electroactive material particles defining the plurality has a coating that includes an oxygen storage material.

In one aspect, the coating including the oxygen storage material may be a continuous coating that is disposed around the surface of the lithium-rich, manganese-rich layered electroactive material particles.

In one aspect, the lithium-rich, manganese-rich layered electroactive material particles defining the plurality may have an average particle size greater than or equal to about 500 nanometers to less than or equal to about 50 micrometers, and the continuous coating may have an average thickness greater than or equal to about 10 nanometers to less than or equal to about 5 micrometers.

In one aspect, the oxygen storage material may be a perovskite selected from the group consisting of: La₍₁₋ₓ₎SrₓMnO₃ (where 0≤x≤0.3), La₍₁₋ₓ₎SrₓFeO₃ (where 0≤x≤0.3), La₍₁₋ₓ₎CaₓMnO₃ (where 0≤x≤0.3), La₍₁₋ₓ₎BaₓMnO₃ (where 0≤x≤0.3), LaMnO₃, LaFeO₃, and combinations thereof.

In one aspect, the oxygen storage material may be a mixed oxide selected from the group consisting of: CeO₂, CeO₂—MnOₓ (where 3≤x≤4), CeO₂—FeOₓ (where 2≤x≤3), CeO₂—WO₃, CeO₂—MoO₆, and combinations thereof.

In one aspect, the oxygen storage material may be selected from the group consisting of: La₍₁₋ₓ₎SrₓMnO₃ (where 0≤x≤0.3), La₍₁₋ₓ₎SrₓFeO₃ (where 0≤x≤La₍₁₋ₓ₎CaₓMnO₃ (where 0≤x≤0.3), La₍₁₋ₓ₎BaₓMnO₃ (where 0≤x≤0.3), LaMnO₃, LaFeO₃, LaMnO₃, LaFeO₃, CeO₂, CeO₂—MnOₓ (where 3≤x≤4), CeO₂—FeOₓ (where 2≤x≤3), CeO₂—WO₃, CeO₂—MoO₆, and combinations thereof.

In one aspect, the lithium-rich, manganese-rich layered electroactive material particles may include an electroactive material represented by:

xLi₂MnO₃·(1−x)LiMO₂

where M is selected from the group consisting of: manganese (Mn), nickel (Ni), cobalt (Co), iron (Fe), and combinations thereof and 0.1≤x≤0.9.

In one aspect, the electroactive material may include greater than or equal to about 0.5 wt. % to less than or equal to about 10 wt. % of the oxygen storage material.

In various aspects, the present disclosure provides an electrochemical cell that cycles lithium ions. The electrochemical cell may include a first electrode, a second electrode, and a separating layer disposed between the first electrode and the second electrode. The first electrode may include a negative electroactive material. The second electrode may include a positive electroactive material. The positive electroactive material may include a plurality of lithium-rich, manganese-rich layered electroactive material particles, where at least a portion of the lithium-rich, manganese-rich layered electroactive material particles of the plurality has a coating comprising an oxygen storage material.

In one aspect, the coating including the oxygen storage material may be a continuous coating disposed around a surface of the lithium-rich, manganese-rich layered electroactive material particles.

In one aspect, the lithium-rich, manganese-rich layered electroactive material particles defining the plurality may have an average particle size greater than or equal to about 500 nanometers to less than or equal to about 50 micrometers, and the coating may have an average thickness greater than or equal to about 10 nanometers to less than or equal to about 5 micrometers.

In one aspect, the second electrode may include greater than or equal to about 80 wt. % to less than or equal to about 98 wt. % of the positive electroactive material, and the positive electroactive material may include greater than or equal to about 0.5 wt. % to less than or equal to about 10 wt. % of the oxygen storage material.

In one aspect, the oxygen storage material may be selected from the group consisting of: La₍₁₋ₓ₎SrₓMnO₃ (where 0≤x≤0.3), La₍₁₋ₓ₎SrₓFeO₃ (where 0≤x≤0.3), La₍₁₋ₓ₎CaₓMnO₃ (where 0≤x≤0.3), La₍₁₋ₓ₎BaₓMnO₃ (where 0≤x≤0.3), LaMnO₃, LaFeO₃, LaMnO₃, LaFeO₃, CeO₂, CeO₂—MnOₓ (where 3≤x≤4), CeO₂—FeOₓ (where 2≤x≤3), CeO₂—WO₃, CeO₂—MoO₆, and combinations thereof.

In one aspect, lithium-rich, manganese-rich layered electroactive material particles may include an electroactive material represented by:

xLi₂MnO₃·(1−x)LiMO₂

where M is selected from the group consisting of: manganese (Mn), nickel (Ni), cobalt (Co), iron (Fe), and combinations thereof and 0.1≤x≤0.9.

In one aspect, the positive electroactive material may be a first positive electroactive material, and the second electrode may further include a second positive electroactive material. The second positive electroactive material may be selected from the group consisting of: a layered oxide represented by LiMeO₂, an olivine-type oxide represented by LiMePO₄, a monoclinic-type oxide represented by Li₃Me₂(PO₄)₃, a spinel-type oxide, a tavorite represented by LiMeSO₄F, a tavorite represented by LiMePO₄F, and combinations thereof, where Me is a transition metal selected from the group consisting of: cobalt (Co), nickel (Ni), manganese (Mn), iron (Fe), aluminum (Al), vanadium (V), or combinations thereof.

In various aspects, the present disclosure provides a method for forming an electroactive material for use in an electrochemical cell that cycles lithium ions. The method may include contacting a plurality of lithium-rich, manganese-rich layered electroactive material precursor particles with a precursor solution to form a slurry. The precursor solution may be a citric acid water solution that includes a nitrate precursor selected from the group consisting of: lanthanum nitrate, strontium nitrate, manganese nitrate, and combinations thereof. The method may further include drying the slurry to form a coating on a surface of at least a portion of the lithium-rich, manganese-rich layered electroactive material precursor particles defining the plurality.

In one aspect, the coating may include an oxygen storage material selected from the group consisting of: La₍₁₋ₓ₎SrₓMnO₃ (where 0≤x≤0.3), La(1-x)SrₓFeO₃ (where 0≤x≤0.3), La₍₁₋ₓ₎CaₓMnO₃ (where 0≤x≤0.3), La₍₁₋ₓ₎BaₓMnO₃ (where 0≤x≤0.3), LaMnO₃, LaFeO₃, LaMnO₃, LaFeO₃, CeO₂, CeO₂—MnOₓ (where 3≤x≤4), CeO₂—FeOₓ (where 2≤x≤3), CeO₂—WO₃, CeO₂—MoO₆, and combinations thereof.

In one aspect, the lithium-rich, manganese-rich layered electroactive material particles defining the plurality may have an average particle size greater than or equal to about 50 nanometers to less than or equal to about 30 micrometers, and the coating may have an average thickness greater than or equal to about 100 nanometers to less than or equal to about 2 micrometers.

In one aspect, the method may further include preparing the precursor solution by contacting the nitrate precursor and citric acid to water. For example, the precursor solution may include greater than or equal to about 1 wt. % to less than or equal to about 30 wt. % of the citric acid and greater than or equal to about 0.5 wt. % to less than or equal to about 20 wt. % of the nitrate precursor.

In one aspect, the method may further include calcining the coating at a temperature greater than or equal to about 350° C. to less than or equal to about 900° C. for a period greater than or equal to about 1 hour to less than or equal to about 10 hours.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical battery cell including coated positive electroactive material particles in accordance with various aspects of the present disclosure;

FIG. 2 is an illustration of an example lithium-rich, manganese-rich layered electroactive material particle having an oxygen storage material coating in accordance with various aspects of the present disclosure;

FIG. 3 is a flowchart illustrating an example method for forming coated positive electroactive material particles in accordance with various aspects of the present disclosure;

FIG. 4A is a microscopy image of an untreated positive electroactive material particle in accordance with various aspects of the present disclosure;

FIG. 4B is a microscopy image of a positive electroactive material particle treated in accordance with various aspects of the present disclosure;

FIG. 5A is a graphical illustration demonstrating the first cycle efficiency and discharge capacity of example cells including coated positive electroactive material particles in accordance with various aspects of the present disclosure; and

FIG. 5B is a graphical illustration demonstrating the first cycle dQ/dV of example including coated positive electroactive material particles in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to particle coatings for lithium-rich, manganese-rich layered electroactive materials, to electrodes and electrochemical cells including coated lithium-rich, manganese-rich layered electroactive material particles, and to methods of making and using the same. The electrodes and electrochemical cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

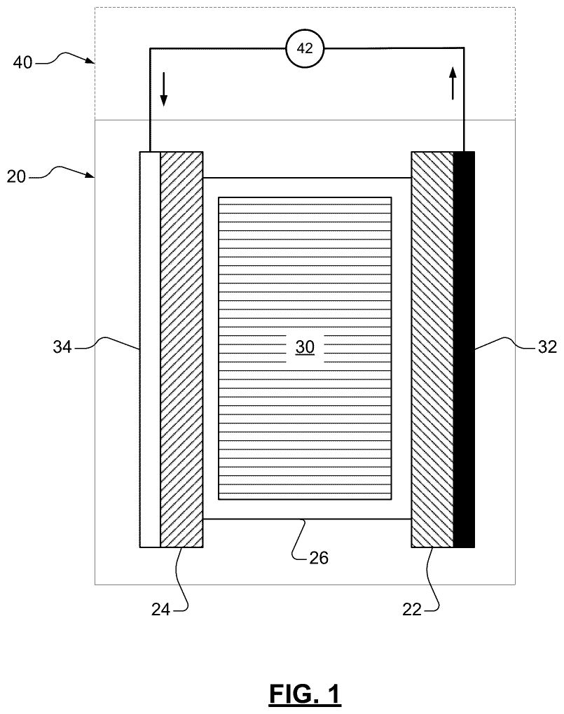

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode 24. The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3-}xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, L₁₃OCl, Li_{2.99}Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22.

The negative electrode 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. For example, in certain variations, the negative electrode 22 may include a plurality of solid-state electrolyte particles. In each instance, the negative electrode 22 (including the one or more layers) may have a thickness greater than or equal to about 0 nm to less than or equal to about 500 μm, optionally greater than or equal to about 1 μm to less than or equal to about 500 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. For example, in certain variations, the negative electrode 22 may be defined by a lithium metal foil. In other variations, the negative electrode 22 may include, for example only, carbonaceous negative electroactive materials (such as, graphite, hard carbon, soft carbon, and the like) and/or metallic negative electroactive materials (such as tin, aluminum, magnesium, germanium, and alloys thereof, and the like). In further variations, the negative electrode 22 may include a silicon-based negative electroactive material.

In still further variations, the negative electrode 22 may be a composite electrode including a combination of negative electroactive materials. For example, the negative electrode 22 may include a first negative electroactive material and a second negative electroactive material. In certain variations, a ratio of the first negative electroactive material to the second negative electroactive material may be greater than or equal to about 5:95 to less than or equal to about 95:5. The first negative electroactive material may be a volume-expanding negative electroactive material including, for example, silicon, aluminum, germanium, and/or tin. The second negative electroactive material may include a carbonaceous negative electroactive material (e.g., graphite, hard carbon, and/or soft carbon). For example, in certain variations, the negative electroactive material may include a carbonaceous-silicon based composite including, for example, about 10 wt. % SiOₓ (where 0≤x≤2) and about 90 wt. % graphite. In each instance, the negative electroactive material may be prelithiated.

In each variation, the negative electroactive material may be optionally intermingled with an electronically conductive material (i.e., conductive additive) that provide an electron conductive path and/or a polymeric binder material that improve the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electroactive material includes lithium-rich, manganese-rich layered electroactive material represented, for example, by xLi₂MnO₃ (1−x)LiMO₂ (where M is selected from the group consisting of manganese (Mn), nickel (Ni), cobalt (Co), iron (Fe), and combinations thereof and 0.1≤x≤0.9). In other variations, the positive electrode 24 may be a composite electrode. For example, the positive electrode 24 may include a first positive electroactive material and a second electroactive material. A ratio of the first positive electroactive material to the second positive electroactive material may be greater than or equal to about 5:95 to less than or equal to about 95:5. In certain variations, the first electroactive material may include the lithium-rich, manganese-rich layered electroactive material, and the second electroactive material may include a layered oxide represented by LiMeO₂, where Me is a transition metal, such as cobalt (Co), nickel (Ni), manganese (Mn), iron (Fe), aluminum (Al), vanadium (V), or combinations thereof, an olivine-type oxide represented by LiMePO₄, where Me is a transition metal, such as cobalt (Co), nickel (Ni), manganese (Mn), iron (Fe), aluminum (Al), vanadium (V), or combinations thereof, a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof, a spinel-type oxide represented by LiMe₂O₄, where Me is a transition metal, such as cobalt (Co), nickel (Ni), manganese (Mn), iron (Fe), aluminum (Al), vanadium (V), or combinations thereof, and/or a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof.

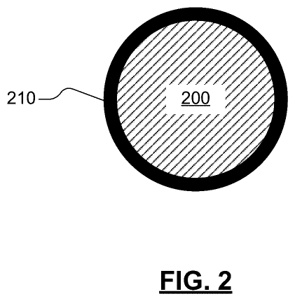

In each variation, the lithium-rich, manganese-rich layered electroactive material includes a plurality of lithium-rich, manganese-rich layered electroactive material particles and at least a portion of the lithium-rich, manganese-rich layered electroactive material particles defining the plurality are coated with an oxygen storage material. For example, FIG. 2 illustrates an example lithium-rich, manganese-rich layered electroactive material particle 200 coated with an oxygen storage material 210. As illustrated, the oxygen storage material coating may be a substantially continuous coating covering greater than or equal to about 85%, optionally greater than or equal to about 90%, optionally greater than or equal to about 95%, optionally greater than or equal to about 98%, optionally greater than or equal to about 99%, and in certain aspects, greater than or equal to about 99.5, of a total exposed surfaces area of the lithium-rich, manganese-rich layered electroactive material particle 200. In certain variations, the lithium-rich, manganese-rich layered electroactive material particle 200 may have a particle size greater than or equal to about 500 nanometers to less than or equal to about 50 μm, and in certain aspects, optionally greater than or equal to about 5 μm to less than or equal to about 20 μm, and the an oxygen storage material coating 210 may have an average thickness greater than or equal to about 10 nm to less than or equal to about 5 μm, and in certain aspects, optionally greater than or equal to about 100 nm to less than or equal to about 1 μm. The oxygen storage material 210 may include, for example, a perovskite and/or a mixed oxide. The perovskite may include La₍₁₋ₓ₎MeₓMnO₃, where Me is selected from the group consisting of: nickel (Ni), strontium (Sr), calcium (Ca), barium (Ba), and combinations thereof and 0≤x≤0.3, such as La₍₁₋ₓ₎SrₓMnO₃ (where 0≤x≤0.3) (e.g., La_{0.9}Sr_{0.1}MnO₃, where x=0.1), La₍₁₋ₓ₎CaₓMnO₃ (where 0≤x≤0.3), and/or La₍₁₋ₓ₎BaₓMnO₃ (where 0≤x≤0.3). The perovskite may additionally or alternatively include La₍₁₋ₓ₎SrₓFeO₃ (where 0≤x≤0.3), LaMnO₃, and/or LaFeO₃. The mixed oxide may include CeO₂, CeO₂—MnOₓ (where 3<x≤4), CeO₂—FeOₓ (where 2≤x≤3), CeO₂—WO₃, and/or CeO₂—MoO₆. In each variation, the oxygen storage material 210 may serve as an oxygen buffer for the lithium-rich, manganese-rich layered electroactive material particle 200 during oxygen redox reactions so as to help increase the first cycle discharging capacities and efficiencies of the cell 20. The oxygen storage material 210 may also serve as a protection layer so as to limit or mitigate manganese dissolution.

With renewed reference to FIG. 1, in various aspects, the positive electrode 24 may include greater than or equal to about 0.05 wt. % to less than or equal to about 10 wt. %, optionally greater than or equal to about 0.5 wt. % to less than or equal to about 5 wt. %, and in certain aspects, optionally greater than or equal to about 0.5 wt. % to less than or equal to about 3 wt. %, of the oxygen storage material. In certain variations, the positive electroactive material may be optionally intermingled with an electronically conductive material (i.e., conductive additive) that provide an electron conductive path and/or a polymeric binder material that improve the structural integrity of the positive electrode 24. For example, the positive electrode 24 may include greater than or equal to about 30 wt. % to less than or equal to about 98 wt. %, and in certain aspects, optionally greater than or equal to about 60 wt. % to less than or equal to about 97 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder. The conductive additive and/or binder material as included in the positive electrode 24 may be the same as or different from the conductive additive and/or binder material as included in the negative electrode 22.

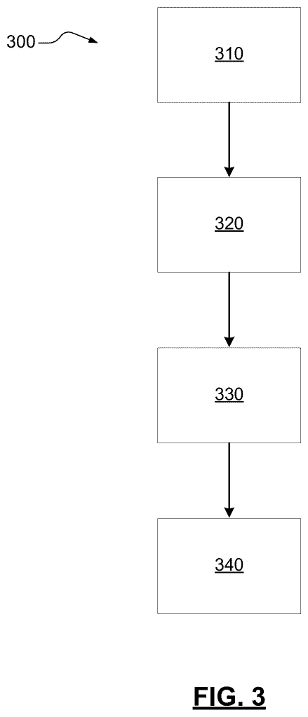

In various aspects, the present disclosure provides methods for forming oxygen storage material particle coatings on positive electroactive material particles. For example, as illustrated in FIG. 3, an example method 300 may include contacting 320 the positive electroactive material particles (for example, the lithium-rich, manganese-rich layered electroactive material particles) with a precursor solution. In certain variations, the contacting 320 may include spraying the precursor solution onto the positive electroactive material particles. The contacting 320 may also include mixing together the positive electroactive material particles and the precursor solution to form a substantially homogeneous solution.

In each instance, the precursor solution may be a citric acid water solution include lanthanum nitrate, strontium nitrate, and/or manganese nitrate, which are precursors to the oxygen storage material. For example, the precursor solution may include greater than or equal to about 1.0 wt. % to less than or equal to about 30 wt. % of the citric acid and greater than or equal to about 0.5 wt. % to less than or equal to about 20 wt. % of the oxygen storage material precursor (i.e., the include lanthanum nitrate, strontium nitrate, and/or manganese nitrate). In certain variations, the method 300 may include preparing 310 the precursor solution by contacting the oxygen storage material precursor and citric acid to water concurrently or consequently. For example, in certain variations, the oxygen storage material precursors may be dissolved in water to form a salt solution and the citric acid may be added to the salt solution.

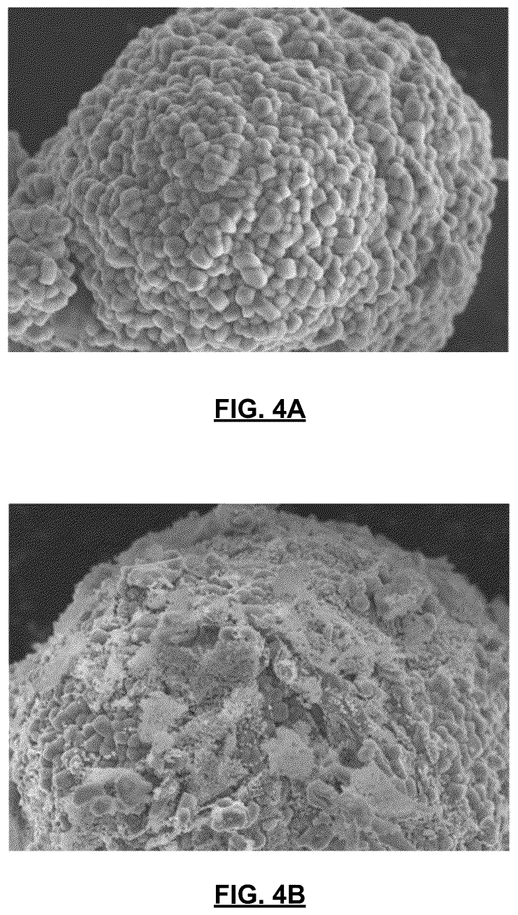

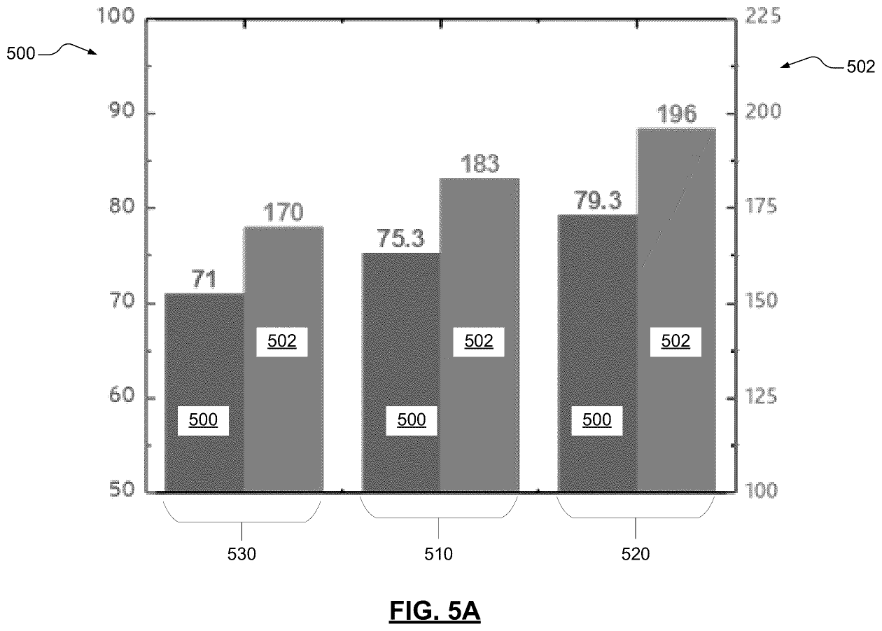

In each instance, the method 300 further comprises drying 330 the slurry to precipitate the oxygen storage material as particle coatings on the positive electroactive material particles. For example, the drying 330 may include heating the slurry to a sufficient temperature (e.g., about 120° C.) for s sufficient period (e.g., about 5 hours). In certain variations, the method 300 may also include calcining 340 the particle coatings. For example, the particle coatings may be heated to a temperature greater than or equal to about 350° C. to less than or equal to about 950° C., and in certain aspects, optionally about 700° C., for a period greater than or equal to about 1 hour to less than or equal to about 20 hours, and in certain aspects, optionally about 5 hours. For comparison only, FIG. 4A is a microscopy image (having a 3.00 μm scale) of an untreated positive electroactive material, while FIG. 4B is a microscopy image (having a 3.00 μm scale) of the positive electroactive material including the oxygen storage material particle coatings.

Certain features of the current technology are further illustrated in the following non-limiting examples.

### Example 1

Example batteries and battery cells may be prepared in accordance with various aspects of the present disclosure.

For example, a first example cell 510 may include a positive electrode that includes, for example, about 93.5 wt. % of a positive electroactive material, about 4 wt. % of a conductive additive (for example, carbon black), and about 2.5 wt. % of a binder additive (for example, polyvinylidene fluoride (PVdF)). The positive electroactive material may include a plurality of lithium-rich, manganese-rich layered electroactive material particles where at least a portion of the lithium-rich, manganese-rich layered electroactive material particles defining the plurality is coated with an oxygen storage material. For example, the positive electroactive material may include about 1 wt. % of the oxygen storage material.

A second example cell 520 may include a positive electrode that includes, for example, about 93.5 wt. % of a positive electroactive material, about 4 wt. % of a conductive additive (for example, carbon black), and about 2.5 wt. % of a binder additive (for example, polyvinylidene fluoride (PVdF)). The positive electroactive material may include a plurality of lithium-rich, manganese-rich layered electroactive material particles where at least a portion of the lithium-rich, manganese-rich layered electroactive material particles defining the plurality is coated with an oxygen storage material. For example, the positive electroactive material may include about 2 wt. % of the oxygen storage material.

A comparative cell 530 may include a positive electrode that includes, for example, about 93.5 wt. % of a positive electroactive material, about 4 wt. % of a conductive additive (for example, carbon black), and about 2.5 wt. % of a binder additive (for example, polyvinylidene fluoride (PVdF)). Like the first and second example cells 510, 520, the comparative cell 530 may include a plurality of lithium-rich, manganese-rich layered electroactive material particles. However, unlike the first and second example cells 510, 520 the comparative cell 530 does not include the oxygen storage material particle coatings.

Each of the cells 510, 520, 530 has a cathode loading of about 4.5 mAh/cm 2 and also includes a negative electrode including, for example, a silicon-graphite composite material and an anode loading of about 5.5 mAh/cm 2. A formation cycle protocol for each of the cells 510, 520, 530 may include for charging: (i) CCC@C/20 to 4.7 V and (ii) CVC@4.7V until C/50 and for discharge: (i) CC@C/20 to 2.0 V. A life cycle protocol for each of the cells 510, 520, 530 may include for charging: (i) CCC@C/3 to 4.6V and (ii) CVC@ 4.6V until C/20 and for discharge: (i) CC@ C/3 to 2.0V.

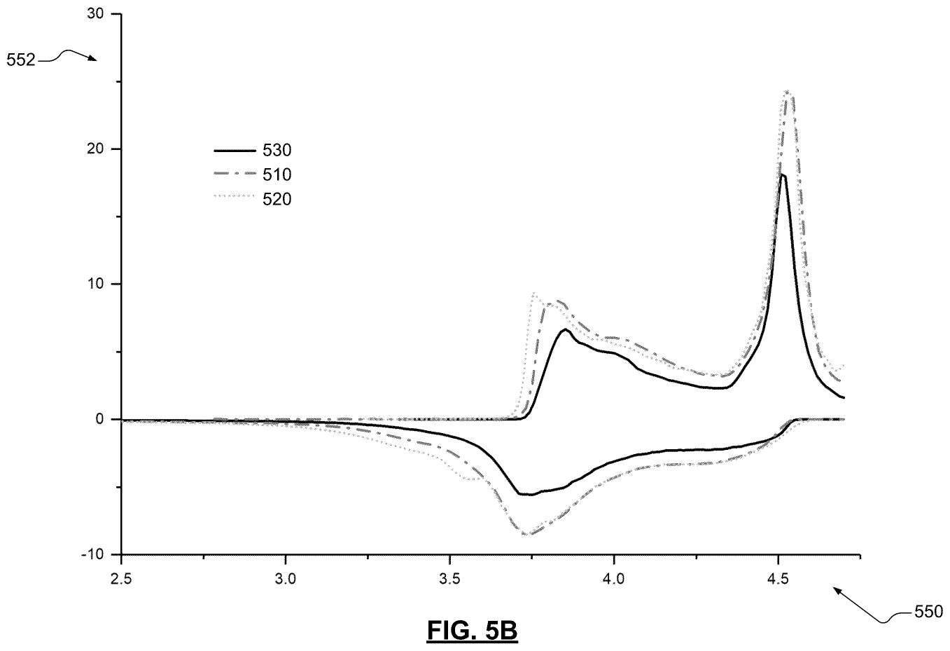

FIG. 5A is a graphical illustration demonstrating the first cycle efficiency and discharge capacity of the example cells 510, 520 as compared to the comparative cell 530, where the y₁-axis 300 represents first cycle efficiency (%), and the y₂-axis 302 represents the first C/3 discharge capacity (mAh/g). As illustrated, the example cell 520 has about a 10% increase in first cycle efficiency (500) and about a 15% increase in the first C/3 discharge specific capacity (502).

FIG. 5B is a dQ/dV curve illustrate the first cycle of the example cells 510, 520 as compared to the comparative cell 530, where x-axis 550 is voltage 500, and the y-axis is dQ/dV. As illustrated, the example cells 510, 520 show higher peak intensities within the same potential range as compared to the comparative cell 530. Also, the potential shifts in peak position during charge and discharge of the example cells 510, 520 are smaller as compared to the comparative cell 530, which indicates a lower resistance.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electroactive material for an electrochemical cell that cycles lithium ions, the electroactive material comprising:
a plurality of lithium-rich, manganese-rich layered electroactive material particles, at least a portion of the lithium-rich, manganese-rich layered electroactive material particles defining the plurality having a coating comprising an oxygen storage material.

2. The electroactive material of claim 1, wherein the coating comprising the oxygen storage material is a continuous coating disposed around the surface of the lithium-rich, manganese-rich layered electroactive material particles.

3. The electroactive material of claim 2, wherein the lithium-rich, manganese-rich layered electroactive material particles defining the plurality of lithium-rich, manganese-rich layered electroactive material particle have an average particle size greater than or equal to about 500 nanometers to less than or equal to about micrometers, and the continuous coating has an average thickness greater than or equal to about 10 nanometers to less than or equal to about 5 micrometers.

4. The electroactive material of claim 1, wherein the oxygen storage material is a perovskite selected from the group consisting of: La₍₁₋ₓ₎ SrₓMnO₃ (where 0≤x≤0.3), La₍₁₋ₓ₎SrₓFeO₃ (where 0≤x≤0.3), La₍₁₋ₓ₎CaₓMnO₃ (where 0≤x≤0.3), La₍₁₋ₓ₎BaₓMnO₃ (where 0≤x≤0.3), LaMnO₃, LaFeO₃, and combinations thereof.

5. The electroactive material of claim 1, wherein the oxygen storage material is a mixed oxide selected from the group consisting of: CeO₂, CeO₂—MnOₓ (where 3≤x≤4), CeO₂—FeOₓ (where 2≤x≤3), CeO₂—WO₃, CeO₂—MoO₆, and combinations thereof.

6. The electroactive material of claim 1, wherein the oxygen storage material is selected from the group consisting of: La₍₁₋ₓ₎ SrₓMnO₃ (where 0≤x≤0.3), La₍₁₋ₓ₎SrₓFeO₃ (where 0≤x≤0.3), La₍₁₋ₓ₎CaₓMnO₃ (where 0≤x≤0.3), La₍₁₋ₓ₎BaₓMnO₃ (where 0≤x≤0.3), LaMnO₃, LaFeO₃, LaMnO₃, LaFeO₃, CeO₂, CeO₂—MnOₓ (where 3≤x≤4), CeO₂—FeOₓ (where 2≤x≤3), CeO₂—WO₃, CeO₂—MoO₆, and combinations thereof.

7. The electroactive material of claim 1, wherein the lithium-rich, manganese-rich layered electroactive material particles comprise an electroactive material represented by:
xLi₂MnO₃·(1−x)LiMO₂
where M is selected from the group consisting of: manganese (Mn), nickel (Ni), cobalt (Co), iron (Fe), and combinations thereof and 0.1≤x≤0.9.

8. The electroactive material of claim 1, wherein the electroactive material comprises greater than or equal to about 0.5 wt. % to less than or equal to about 10 wt. % of the oxygen storage material.

9. An electrochemical cell that cycles lithium ions, the electrochemical cell comprising:
a first electrode comprising a negative electroactive material;
a second electrode comprising a positive electroactive material, the positive electroactive material comprising a plurality of lithium-rich, manganese-rich layered electroactive material particles, at least a portion of the lithium-rich, manganese-rich layered electroactive material particles defining the plurality having a coating comprising an oxygen storage material; and
a separating layer disposed between the first electrode and the second electrode.

10. The electrochemical cell of claim 9, wherein the coating comprising the oxygen storage material is a continuous coating disposed around a surface of the lithium-rich, manganese-rich layered electroactive material particles.

11. The electrochemical cell of claim 9, wherein the lithium-rich, manganese-rich layered electroactive material particles defining the plurality of lithium-rich, manganese-rich layered electroactive material particles have an average particle size greater than or equal to about 500 nanometers to less than or equal to about micrometers, and the coating has an average thickness greater than or equal to about nanometers to less than or equal to about 5 micrometers.

12. The electrochemical cell of claim 9, wherein the second electrode comprises greater than or equal to about 80 wt. % to less than or equal to about 98 wt. % of the positive electroactive material, and the positive electroactive material comprises greater than or equal to about 0.5 wt. % to less than or equal to about 10 wt. % of the oxygen storage material.

13. The electrochemical cell of claim 9, wherein the oxygen storage material is selected from the group consisting of: La₍₁₋ₓ₎SrₓMnO₃ (where 0≤x≤0.3), La₍₁₋ₓ₎SrₓFeO₃ (where 0≤x≤0.3), La₍₁₋ₓ₎CaₓMnO₃ (where 0≤x≤0.3), La₍₁₋ₓ₎BaₓMnO₃ (where 0≤x≤0.3), LaMnO₃, LaFeO₃, LaMnO₃, LaFeO₃, CeO₂, CeO₂—MnOₓ (where 3≤x≤4), CeO₂—FeOₓ (where 2≤x≤3), CeO₂—WO₃, CeO₂—MoO₆, and combinations thereof.

14. The electrochemical cell of claim 9, wherein the lithium-rich, manganese-rich layered electroactive material particles comprise an electroactive material represented by:
xLi₂MnO₃·(1−x)LiMO₂
where M is selected from the group consisting of: manganese (Mn), nickel (Ni), cobalt (Co), iron (Fe), and combinations thereof and 0.1≤x≤0.9.

15. The electrochemical cell of claim 9, wherein the positive electroactive material is a first positive electroactive material, and the second electrode further comprises a second positive electroactive material selected from the group consisting of: a layered oxide represented by LiMeO₂, an olivine-type oxide represented by LiMePO₄, a monoclinic-type oxide represented by Li₃Me₂(PO₄)₃, a spinel-type oxide, a tavorite represented by LiMeSO₄F, a tavorite represented by LiMePO₄F, and combinations thereof, wherein Me is a transition metal selected from the group consisting of: cobalt (Co), nickel (Ni), manganese (Mn), iron (Fe), aluminum (Al), vanadium (V), or combinations thereof.

16. A method for forming an electroactive material for use in an electrochemical cell that cycles lithium ions, the method comprising:
contacting a plurality of lithium-rich, manganese-rich layered electroactive material precursor particles with a precursor solution to form a slurry, the precursor solution being a citric acid water solution comprising a nitrate precursor selected from the group consisting of: lanthanum nitrate, strontium nitrate, manganese nitrate, and combinations thereof; and
drying the slurry to form a coating on a surface of at least a portion of the lithium-rich, manganese-rich layered electroactive material precursor particles defining the plurality.

17. The method of claim 16, wherein the coating comprises an oxygen storage material selected from the group consisting of: La₍₁₋ₓ₎ SrₓMnO₃ (where 0≤x≤0.3), La₍₁₋ₓ₎SrₓFeO₃ (where 0≤x≤0.3), La₍₁₋ₓ₎CaₓMnO₃ (where 0≤x≤0.3), La₍₁₋ₓ₎BaₓMnO₃ (where 0≤x≤0.3), LaMnO₃, LaFeO₃, LaMnO₃, LaFeO₃, CeO₂, CeO₂—MnOₓ (where 3≤x≤4), CeO₂—FeOₓ (where 2≤x≤3), CeO₂—WO₃, CeO₂—MoO₆, and combinations thereof.

18. The method of claim 16, wherein the lithium-rich, manganese-rich layered electroactive material particles defining the plurality of lithium-rich, manganese-rich layered electroactive material particles have an average particle size greater than or equal to about 50 nanometers to less than or equal to about 30 micrometers, and the coating has an average thickness greater than or equal to about 100 nanometers to less than or equal to about 2 micrometers.

19. The method of claim 16, further comprising preparing the precursor solution by contacting the nitrate precursor and citric acid to water, the precursor solution comprising greater than or equal to about 1 wt. % to less than or equal to about 30 wt. % of the citric acid and greater than or equal to about 0.5 wt. % to less than or equal to about 20 wt. % of the nitrate precursor.

20. The method of claim 16, further comprising calcining the coating at a temperature greater than or equal to about 350° C. to less than or equal to about 900° C. for a period greater than or equal to about 1 hour to less than or equal to about 10 hours.
